(19) United States
(12) Patent Application Publication
(10) Pub. No.: US 2019/0075787 A1
(43) Pub. Date: Mar. 14, 2019

(54) COMPOSITIONS AND METHODS FOR CROP DEFENSE

(71) Applicant: AdvanSix Resins & Chemicals LLC, Parsippany, NJ (US)

(72) Inventors: Edward Asirvatham, Chatham, NJ (US); Robert W. Emblidge, Richmond, VA (US); Kristi Engelman, Richmond, VA (US); Jaime A. Flores-Vasquez, Glen Allen, VA (US); Kevin Kashurba, Chesterfield, VA (US); Scott R. Keenan, Marlton, NJ (US); James A. Kweeder, Chesterfield, VA (US); Venkata Krishna Sai Pappu, Henrico, VA (US); Lihao Tang, Bridgewater, NJ (US); Xiawei Zhang, West Chester, PA (US)

(21) Appl. No.: 16/130,055

(22) Filed: Sep. 13, 2018

Related U.S. Application Data
(60) Provisional application No. 62/558,567, filed on Sep. 14, 2017.

(51) Int. Cl. A01N 25/02

(52) U.S. Cl. CPC A01N 25/02; A01N 43/54; A01N 2300/00

(57) ABSTRACT

A composition including a caprolactam-derived solvent and a crop protective active ingredient. An emulsifiable concentrate including a caprolactam-derived solvent, an organic co-solvent, an emulsifier, and a crop protective active ingredient is also provided.

### CROSS-REFERENCE TO RELATED APPLICATIONS

This application claims the benefit under Title 35, U.S.C. § 119(e) of U.S. Provisional Application Ser. No. 62/558,567 entitled COMPOSITIONS AND METHODS FOR CROP DEFENSE, filed on Sep. 14, 2017, the entire disclosure of which is expressly incorporated by reference herein.

### FIELD

The present disclosure relates to compositions for crop defense. In particular, the disclosure relates to compositions including pesticides and to methods of making and using such compositions.

### BACKGROUND

Some important crop protective active ingredients, or pesticides including herbicides, insecticides, and fungicides, are soluble in organic solvents, but are not soluble in water. Some important crop protective active ingredients are soluble in water, but are sensitive to water and tend to decompose over time. Such pesticides may be applied to crops in the form of an emulsion of small droplets of organic solvents that are finely dispersed in water. The droplets of organic solvents contain the pesticides.

The emulsion containing the pesticide is often formed at the time of use by combining an emulsifiable concentrate (EC) with water. In addition to the pesticide and one or more organic solvents, the EC may include an emulsifier so that the emulsion forms quickly and readily when the EC is added to water. In some cases, the nature of the solvents used in the EC results in the pesticide being suspended in the solvents, rather than dissolved in the solvents. Pesticides that are suspended in the EC, rather than dissolved in the EC, may eventually fall out of suspension, for example, in storage or transportation, particularly under low temperature conditions. The pesticides that fall out of suspension may clog application equipment nozzles and prevent the proper application of the pesticides to the crops or to the fields in which the crops are to be planted.

Thus, it is beneficial that the one or more solvents in the EC are able to readily dissolve the pesticides, especially at higher pesticide concentrations desirable in the EC. In some cases, the one or more solvents include N-methyl-2-pyrrolidone (NMP) or isophorone. NMP and isophorone are excellent solvents for many of the most difficult to dissolve pesticides. However, NMP has been found to be a reproductive toxin and isophorone is a suspected carcinogen. What are needed are solvents that readily dissolve pesticides and are neither reproductive toxins nor suspected carcinogens.

### SUMMARY

The present disclosure provides a composition including a crop protective active ingredient and a caprolactam-derived solvent that mitigates or eliminates disadvantages associated with traditional solvents. The composition may be useful applying the crop protective active ingredient to crops or to fields in which crops are to be planted.

In one form thereof, the present disclosure provides a composition including a caprolactam-derived solvent and a crop protective active ingredient dissolved in the caprolactam-derived solvent. The caprolactam-derived solvent is according to the general formula:

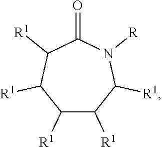

in which R is a linear, branched, or cyclic alkyl group of 1 to 6 unsubstituted or substituted carbons and R¹ are independently selected from the group consisting of: H or an alkyl group with substituted or unsubstituted carbons.

The caprolactam-derived solvent may be according to the general formula:

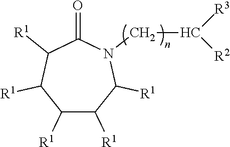

in which n is 0 or 1, R¹ are independently selected from the group consisting of: H or an alkyl group with substituted or unsubstituted carbons, R² is independently selected from the group consisting of: H or —CH₃, and R³ is independently selected from the group consisting of: H, —CH₃, a fluoro alkyl of 1 to 3 carbons, and —C(O)NR⁴R⁴, wherein R⁴ is selected from the group consisting of: —CH₃ or —CH₂CH₃.

The caprolactam-derived solvent may include at least one selected from the group of N-methylcaprolactam, N-ethylcaprolactam, and N-butylcaprolactam. A concentration of the caprolactam-derived solvent may be from 5 weight percent to 50 weight percent of the composition.

The crop protective active ingredient may include at least one selected from the group of a herbicide, an insecticide, and a fungicide.

The crop protective active ingredient may include the herbicide. The herbicide may include at least one selected from the group of ametryne, diuron, linuron, chlortoluron, isoproturon, nicosulfuron, metamitron, aclonifen, atrazine, bromoxynil, bromoxynil heptanoate, bromoxynil octanoate, phenmedipham, propanil, a heteroaryloxyphenoxy series, MCPA (2-methyl-4-chlorophenoxyacetic acid), 2,4-D (2,4-dichlorophenoxyacetic acid), simazine, an imidazolinone, alachlor, diclofop-methyl, fenoxaprop-p-ethyl, bensulfuron-methyl, chlorimuron-ethyl, chlorsulfuron, metsulfuron-methyl, nicosulfuron, sulfometuron-methyl, triasulfuron, tribenuron-methyl, phenmedipham, pendimethalin, trifluralin, oxyfluorfen, fenoxaprop-ethyl, fluazifop-p-butyl, and saflufenacil.

The crop protective active ingredient may include the insecticide. The insecticide may include at least one selected from the group of diazinon, a phenoxyphenoxy series, azinphos-ethyl, azinphos-methyl, chlorpyrifos, methoxychlor, cypermethrin, fenoxycarb, neonicotinoid insecticides, alpha-cypermethrin, dimethoate, imidacloprid, propoxur, deltamethrine, fenvalerate, abamectin, am icarbazone, bifenthrin, carbosulfan, cyfluthrin, etofenprox, fipronil, fenvalerate, flufenoxuron, hexazinone, lambda-cyhalothrin, methomyl, and permethrin.

The crop protective active ingredient may include the fungicide. The fungicide may include at least one selected from the group of chlorothalonil, mancozeb, maneb, zineb, cymoxanil, chlorothalonil, azaconazole, bromuconazole, cyproconazole, difenoconazole, diniconazole, epoxiconazole, fenbuconazole, flusilazole, myclobutanil, tebuconazole, triadimefon, triadimenol, pyraclostrobin, picoxystrobin, azoxystrobin, famoxadone, kresoxim-methyl, trifloxystrobin, triadimenol, benomyl, prochloraz, and propiconazole. A concentration of the crop protective active ingredient may be from 5 weight percent to 75 weight percent of the composition.

The composition may further include an emulsifier. The emulsifier may include at least one selected from the group of ethoxylated glycerin/fatty acid esters, glycerol monooleate, glycerol dioleate, PEG alkoxylated block polymers, alkoxylated alcohols, alkoxylated alkylphenols, alkoxylated amines, alkoxylated amides, alkoxylated fatty esters, alkoxylated oils, fatty esters, alkoxylated fatty acids, sorbitan derivatives, alkylaryl sulfonates, alkylaryl sulfonic acids, carboxylated alcohol ethoxylates, alkylphenol ethoxylates, carboxylic acids, diphenyl sulfonate derivatives, olefin sulfonates, phosphate esters, phosphorous organic derivatives, and quaternary surfactants. A concentration of the emulsifier may be from 5 weight percent to 15 weight percent of the composition.

The composition may further include a co-solvent. The co-solvent may include at least one selected from the group of C₉-C₁₂ hydrocarbon solvents, aliphatic paraffinic oils, aromatic solvents, C₉-C₁₂ aromatic solvents, chlorinated hydrocarbons, alcohols, ketones, ethers, vegetable oils, methylated vegetable oils, petroleum oils, and sugar esters of fatty acids. A concentration of the co-solvent may be from 15 weight percent to 70 weight percent of the composition.

In another form thereof, the present disclosure provides an emulsifiable concentrate including a caprolactam-derived solvent, a crop protective active ingredient dissolved in the caprolactam-derived solvent, an organic co-solvent, and an emulsifier. The caprolactam-derived solvent is according to the general formula:

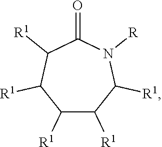

in which R is a linear, branched, or cyclic alkyl group of 1 to 6 unsubstituted or substituted carbons and R¹ are independently selected from the group consisting of: H or an alkyl group with substituted or unsubstituted carbons.

The caprolactam-derived solvent may be according to the general formula:

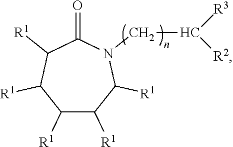

in which n is 0 or 1, R¹ are independently selected from the group consisting of: H or an alkyl group with substituted or unsubstituted carbons, R² is independently selected from the group consisting of: H or —CH₃, and R³ is independently selected from the group consisting of: H, —CH₃, a fluoro alkyl of 1 to 3 carbons, and —C(O)NR⁴R⁴, wherein R⁴ is selected from the group consisting of: —CH₃ or —CH₂CH₃.

The caprolactam-derived solvent may include at least one selected from the group of N-methylcaprolactam, N-ethylcaprolactam, and N-butylcaprolactam. The crop protective active ingredient may include at least one selected from the group of an herbicide, an insecticide, and a fungicide.

The crop protective active ingredient may include the herbicide. The herbicide may include at least one selected from the group of ametryne, diuron, linuron, chlortoluron, isoproturon, nicosulfuron, metamitron, aclonifen, atrazine, bromoxynil, bromoxynil heptanoate, bromoxynil octanoate, phenmedipham, propanil, a heteroaryloxyphenoxy series, MCPA (2-methyl-4-chlorophenoxyacetic acid), 2,4-D (2,4-dichlorophenoxyacetic acid), simazine, an imidazolinone, alachlor, diclofop-methyl, fenoxaprop-p-ethyl, bensulfuron-methyl, chlorimuron-ethyl, chlorsulfuron, metsulfuron-methyl, nicosulfuron, sulfometuron-methyl, triasulfuron, tribenuron-methyl, phenmedipham, pendimethalin, trifluralin, oxyfluorfen, fenoxaprop-ethyl, fluazifop-p-butyl, and saflufenacil.

The crop protective active ingredient may include the insecticide. The insecticide may include at least one selected from the group of diazinon, a phenoxyphenoxy series, azinphos-ethyl, azinphos-methyl, chlorpyrifos, methoxychlor, cypermethrin, fenoxycarb, neonicotinoid insecticides, alpha-cypermethrin, dimethoate, imidacloprid, propoxur, deltamethrine, fenvalerate, abamectin, am icarbazone, bifenthrin, carbosulfan, cyfluthrin, etofenprox, fipronil, fenvalerate, flufenoxuron, hexazinone, lambda-cyhalothrin, methomyl, and permethrin.

The crop protective active ingredient may include the fungicide. The fungicide may include at least one selected from the group of chlorothalonil, mancozeb, maneb, zineb, cymoxanil, chlorothalonil, azaconazole, bromuconazole, cyproconazole, difenoconazole, diniconazole, epoxiconazole, fenbuconazole, flusilazole, myclobutanil, tebuconazole, triadimefon, triadimenol, pyraclostrobin, picoxystrobin, azoxystrobin, famoxadone, kresoxim-methyl, trifloxystrobin, triadimenol, benomyl, prochloraz, and propiconazole.

A concentration of the crop protective active ingredient may be from 5 weight percent to 75 weight percent of the emulsifiable concentrate. A concentration crop protective active ingredient may be from 20 weight percent to 30 weight percent of the emulsifiable concentrate.

The emulsifier may include at least one selected from the group of ethoxylated glycerin/fatty acid esters, glycerol monooleate, glycerol dioleate, PEG alkoxylated block polymers, alkoxylated alcohols, alkoxylated alkylphenols, alkoxylated amines, alkoxylated amides, alkoxylated fatty esters, alkoxylated oils, fatty esters, alkoxylated fatty acids, sorbitan derivatives, alkylaryl sulfonates, alkylaryl sulfonic acids, carboxylated alcohol ethoxylates, alkylphenol ethoxylates, carboxylic acids, diphenyl sulfonate derivatives, olefin sulfonates, phosphate esters, phosphorous organic derivatives, and quaternary surfactants.

The above mentioned and other features of the invention, and the manner of attaining them, will become more apparent and the invention itself will be better understood by reference to the following description of the disclosure.

### DETAILED DESCRIPTION

Compositions and concentrates of the disclosure can employ caprolactam-derived solvents to replace traditional solvents, such as NMP or isophorone, for example, in compositions including crop protective active ingredients. The caprolactam-derived solvents can replace NMP or isophorone in an emulsifiable concentrate containing crop protective active ingredients. The basis of the caprolactam-derived solvents, caprolactam, has not been found to be, and is not expected to be, either a reproductive toxin or a carcinogen. In particular, N-methylcaprolactam is not considered to be either a reproductive toxin or a carcinogen. Thus, the caprolactam-derived solvents, such as N-methylcaprolactam, N-ethylcaprolactam, and N-butylcaprolactam, are significantly safer solvents than NMP and isophorone.

In addition, as shown in the examples below, the caprolactam-derived solvents, such as N-methylcaprolactam, N-ethylcaprolactam, and N-butylcaprolactam, appear to be as effective as NMP and other commonly used solvents, such as methyl-5-(dimethylamino)-2-methyl-5-oxopentanoate and N-butyl-2-pyrrolidone, in dissolving crop protective active ingredients. As is known in the art, Hansen Solubility Parameters can be used to predict the effectiveness of a solvent. With respect to the dissolution of the crop protective active ingredients, one skilled in the art would expect the polarity and hydrogen bonding Hansen Solubility Parameters to be strongly predictive of the effectiveness of a solvent, with generally higher values corresponding to more effective solvents.

A comparison of the Hansen Solubility Parameters for the caprolactam-derived solvents and the some commonly used solvents is shown in Table 1 below. Surprisingly, as shown in Table 1, the polarity and hydrogen bonding Hansen Solubility Parameters for the caprolactam-derived solvents are significantly lower than those for the commonly used solvents. Thus, one skilled in the art would not expect the caprolactam-derived solvents to be as effective as NMP and other commonly used solvents.

TABLE 1

| | Hansen Solubility Parameters | | |
|---|---|---|---|
| | | | Hydrogen |
| Solvent | Dispersion | Polarity | Bonding |
| N-methylcaprolactam | 17.9 | 7.6 | 5.7 |
| N-ethylcaprolactam | 17.7 | 6.7 | 5.2 |
| N-butylcaprolactam | 17.5 | 4.8 | 4.6 |
| N-methyl-2-pyrrolidone | 18.0 | 12.3 | 7.2 |
| N,N-dimethyladipamide methyl ester | 17.2 | 9.7 | 9.3 |
| methyl-5-(dimethylamino)-2-methyl-5- | 15.8 | 10.7 | 9.2 |
| oxopentanoate | | | |

A composition, according to this disclosure, includes a crop protective active ingredient and a caprolactam-derived solvent. The caprolactam-derived solvent is according to the general formula:

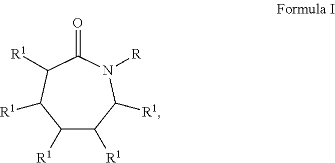

in which R is a linear, branched, or cyclic alkyl group of 1 to 6 unsubstituted or substituted carbons and R¹ are independently selected from the group consisting of: H or an alkyl group with substituted or unsubstituted carbons. For example, if R is a methyl group (—CH₃) and all the R¹ are hydrogens, then the caprolactam-derived solvent is N-methylcaprolactam. If R is an ethyl group (—CH₂CH₃) and all the R¹ are hydrogens, then the caprolactam-derived solvent is N-ethylcaprolactam. If R is a butyl group (—CH₂CH₂CH₂CH₃) and all the R¹ are hydrogens, then the caprolactam-derived solvent is N-butylcaprolactam.

The caprolactam-derived solvent may be according to the general formula:

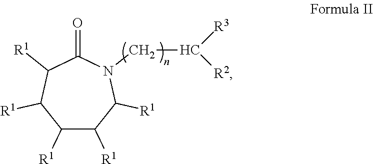

in which n is 0 or 1, R¹ are independently selected from the group consisting of: H or an alkyl group with substituted or unsubstituted carbons, R² is independently selected from the group consisting of: H or —CH₃, and R³ is independently selected from the group consisting of: H, —CH₃, a fluoro alkyl of 1 to 3 carbons, and —C(O)NR⁴R⁴, wherein R⁴ is selected from the group consisting of: —CH₃ or —CH₂CH₃.

For example, if n is 1, all the R¹ are H, R² is H, R³ is —C(O)NR⁴R⁴, and R⁴ is —CH₃, then the caprolactam-derived solvent is:

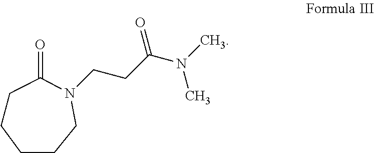

Without wishing to be bound by any theory, it is believed that because the caprolactam-derived solvents according as described above are polar solvents, they are able to dissolve crop protective active ingredients that include polar groups (e.g. amines, halogens, oxygen containing groups). It is further believed that because the caprolactam-derived solvents described above are aprotic, they will not tend to cause the crop protective active ingredients to decompose over time. The caprolactam-derived solvent may be a mixture of two or more of any of the caprolactam-derived solvents as described above.

A concentration of the caprolactam-derived solvent as a weight percentage of the composition may be as low as 5 wt. %, 8 wt. %, 10 wt. %, 11 wt. %, 14 wt. %, or 17 wt. %, or as high as 26 wt. %, 30 wt. %, 32 wt. %, 38 wt. %, 44 wt. %, or 50 wt. %, or within any range defined between any two of the foregoing values, such as 5 wt. % to 50 wt. %, 8 wt. % to 44 wt. %, 10 wt. % to 30 wt. %, 11 wt. % to 38 wt. %, 14 wt. % to 32 wt. %, or 17 wt. % to 26 wt. %, for example.

Crop protective active ingredients, or pesticides, can include herbicides, insecticides, and fungicides. Some non-limiting examples of common herbicides that are not water soluble and are suitable for use in compositions and concentrates of this disclosure include ametryne, diuron, linuron, chlortoluron, isoproturon, nicosulfuron, metamitron, aclonifen, atrazine, bromoxynil, bromoxynil heptanoate, bromoxynil octanoate, phenmedipham, propanil, a heteroaryloxyphenoxy series, MCPA (2-methyl-4-chlorophenoxyacetic acid), 2,4-D (2,4-dichlorophenoxyacetic acid), simazine, an imidazolinone, alachlor, diclofop-methyl, fenoxaprop-p-ethyl, bensulfuron-methyl, chlorimuron-ethyl, chlorsulfuron, metsulfuron-methyl, nicosulfuron, sulfometuron-methyl, triasulfuron, tribenuron-methyl, phenmedipham, pendimethalin, trifluralin, oxyfluorfen, fenoxaprop-ethyl, fluazifop-p-butyl, saflufenacil, and combinations thereof.

Some non-limiting examples of common insecticides that are not water soluble and are suitable for use in compositions and concentrates of this disclosure include diazinon, a phenoxyphenoxy series, azinphos-ethyl, azinphos-methyl, chlorpyrifos, methoxychlor, cypermethrin, fenoxycarb, neonicotinoid insecticides, alpha-cypermethrin, dimethoate, imidacloprid, propoxur, deltamethrine, fenvalerate, abamectin, am icarbazone, bifenthrin, carbosulfan, cyfluthrin, etofenprox, fipronil, fenvalerate, flufenoxuron, hexazinone, lambda-cyhalothrin, methomyl, permethrin, and combinations thereof.

Some non-limiting examples of common fungicides that are not water soluble and are suitable for use in compositions and concentrates of this disclosure include chlorothalonil, mancozeb, maneb, zineb, cymoxanil, chlorothalonil, azaconazole, bromuconazole, cyproconazole, difenoconazole, diniconazole, epoxiconazole, fenbuconazole, flusilazole, myclobutanil, tebuconazole, triadimefon, triadimenol, pyraclostrobin, picoxystrobin, azoxystrobin, famoxadone, kresoxim-methyl, trifloxystrobin, triadimenol, benomyl, prochloraz, propiconazole, and combinations thereof.

A concentration of the crop protective active ingredient as a weight percentage of the composition may be as low as 5 weight percent (wt. %), 8 wt. %, 11 wt. %, 14 wt. %, 17 wt. %, or 20 wt. %, or as high as 30 wt. %, 40 wt. %, 50 wt. %, 60 wt. %, 70 wt. % or 75 wt. %, or within any range defined between any two of the foregoing values, such as 5 wt. % to 75 wt. %, 8 wt. % to 70 wt. %, 11 wt. % to 60 wt. %, 14 wt. % to 50 wt. %, 17 wt. % to 40 wt. %, or 20 wt. % to 30 wt. %, for example.

The composition may further include an organic co-solvent. The organic co-solvent may include an aromatic hydrocarbon solvent, an aliphatic hydrocarbon solvent, or any combination thereof. Such solvents can be less expensive than the caprolactam-derived solvents and thus lower the overall cost of the composition. The organic co-solvent may include C₉-C₁₂ hydrocarbon solvents, aliphatic paraffinic oils such as kerosene or refined paraffins, aromatic solvents such as xylene, C₉-C₁₂ aromatic solvents, chlorinated hydrocarbons such as chlorobenzene, alcohols such as butanol and benzyl alcohol, ketones such as cyclohexanone, and ethers such as diethylene glycol and diethoxol. The organic co-solvent may include vegetable oils, methylated vegetable oils, petroleum oils, and sugar esters of fatty acids. The organic co-solvent may include any combination of the foregoing co-solvents.

A concentration of the organic co-solvent as a weight percentage of the composition may be as low as 15 wt. %, 22 wt. %, 29 wt. %, 36 wt. %, 40 wt. %, or 43 wt. %, or as high as 50 wt. %, 55 wt. %, 60 wt. %, 65 wt. %, or 70 wt. or within any range defined between any two of the foregoing values, such as 15 wt. % to 70 wt. %, 22 wt. % to 65 wt. %, 20 wt. % to 60 wt. %, 36 wt. % to 55 wt. %, 40 wt. % to 50 wt. %, or 43 wt. % to 50 wt. %, for example.

The composition can further include an emulsifier. The emulsifier may include ethoxylated glycerin/fatty acid esters such as ethoxylated glyceryl fatty acid esters (e.g., PEG 20 glyceryl laurate, PEG 20 glyceryl oleate, PEG 20 glyceryl oleoricinoleate, and PEG 20 glyceryl stearate), sorbitan esters and ethoxylated sorbitan esters (e.g., sorbitan monolaurate and sorbitan trioleate), glycerol monooleate, glycerol dioleate, PEG alkoxylated block polymers, alkoxylated alcohols, alkoxylated alkylphenols, alkoxylated amines, alkoxylated amides, alkoxylated fatty esters, alkoxylated oils, fatty esters, alkoxylated fatty acids, sorbitan derivatives, alkylaryl sulfonates, alkylaryl sulfonic acids, carboxylated alcohol ethoxylates, alkylphenol ethoxylates, carboxylic acids, diphenyl sulfonate derivatives, olefin sulfonates, phosphate esters, phosphorous organic derivatives, quaternary surfactants, and combinations thereof.

A concentration of the emulsifier as a weight percentage of the composition may be as low as 5 wt. %, 6 wt. %, 7 wt. %, 8 wt. %, or 9 wt. %, or as high as 11 wt. %, 12 wt. %, 13 wt. %, 14 wt. %, or 15 wt. %, or within any range defined between any two of the foregoing values, such as 5 wt. % to 15 wt. %, 6 wt. % to 14 wt. %, 7 wt. % to 13 wt. %, 8 wt. % to 12 wt. %, 9 wt. % to 11 wt. %, or 8 wt. % to 10 wt. %, for example.

An emulsifiable concentrate (EC), according to this disclosure, includes a crop protective active ingredient, an organic co-solvent, an emulsifier, and a caprolactam-derived solvent, each as described above. The EC may be formed by mixing together the components.

A concentration of the crop protective active ingredient as a weight percentage of the emulsifiable concentrate may be as low as 5 weight percent (wt. %), 8 wt. %, 11 wt. %, 14 wt. %, 17 wt. %, or 20 wt. %, or as high as 30 wt. %, 40 wt. %, 50 wt. %, 60 wt. %, 70 wt. % or 75 wt. %, or within any range defined between any two of the foregoing values, such as 5 wt. % to 75 wt. %, 8 wt. % to 70 wt. %, 11 wt. % to 60 wt. %, 14 wt. % to 50 wt. %, 17 wt. % to 40 wt. %, or 20 wt. % to 30 wt. %, for example.

A concentration of the caprolactam-derived solvent as a weight percentage of the emulsifiable concentrate may be as low as 5 wt. %, 8 wt. %, 10 wt. %, 11 wt. %, 14 wt. %, or 17 wt. %, or as high as 26 wt. %, 30 wt. %, 32 wt. %, 38 wt. %, 44 wt. %, or 50 wt. %, or within any range defined between any two of the foregoing values, such as 5 wt. % to 50 wt. %, 8 wt. % to 44 wt. %, 10 wt. % to 30 wt. %, 11 wt. % to 38 wt. %, 14 wt. % to 32 wt. %, or 17 wt. % to 26 wt. %, for example.

A concentration of the emulsifier as a weight percentage of the emulsifiable concentrate may be as low as 5 wt. %, 6 wt. %, 7 wt. %, 8 wt. %, or 9 wt. %, or as high as 11 wt. %, 12 wt. %, 13 wt. %, 14 wt. %, or 15 wt. %, or within any range defined between any two of the foregoing values, such as 5 wt. % to 15 wt. %, 6 wt. % to 14 wt. %, 7 wt. % to 13 wt. %, 8 wt. % to 12 wt. %, 9 wt. % to 11 wt. %, or 8 wt. % to 10 wt. %, for example.

A concentration of the organic co-solvent as a weight percentage of the emulsifiable concentrate may be as low as 15 wt. %, 22 wt. %, 29 wt. %, 36 wt. %, 40 wt. %, or 43 wt. %, or as high as 50 wt. %, 55 wt. %, 60 wt. %, 65 wt. %, or 70 wt. or within any range defined between any two of the foregoing values, such as 15 wt. % to 70 wt. %, 22 wt. % to 65 wt. %, 20 wt. % to 60 wt. %, 36 wt. % to 55 wt. %, 40 wt. % to 50 wt. %, or 43 wt. % to 50 wt. %, for example.

The EC can be provided to a use location, such as a farm, and diluted on-site with water to a desired application concentration (otherwise known as a tank mixture). Upon dilution with water, the emulsifier in the EC quickly and readily forms an emulsion of organic droplets finely dispersed in the tank mixture. The organic droplets include the caprolactam-derived solvent, the co-solvent, and the crop protective active ingredient.

The organic droplets are not miscible with the water, so that the crop protective active ingredient stays in solution within the organic droplets. This can provide for an even concentration of the crop protective active ingredient in the tank mixture. Once the tank mixture is prepared, the diluted EC is applied to the crops or to the fields in which the crops are to be planted. The diluted EC can be applied by, for example, spraying or dribbling on to the fields or injecting into the soil. Lines and nozzles used to apply the diluted EC are less likely to clog because the crop protective active ingredient stays in solution within the organic droplets.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

While this invention has been described as relative to exemplary designs, the present invention may be further modified within the spirit and scope of this disclosure. Further, this application is intended to cover such departures from the present disclosure as come within known or customary practice in the art to which this invention pertains.

### EXAMPLES

### Example 1—Herbicide Comparative Solubility

The solubility of the herbicide saflufenacil was determined for thirteen solvents. Three of the solvents were caprolactam-derived solvents in accordance with this disclosure. The remaining ten were comparative solvents. The solubility of saflufenacil was evaluated for each solvent by preparing four, 2 ml vials containing 20 wt. %, 30 wt. %, 40 wt. % and 50 wt. % of saflufenacil. To prepare the 20 wt. % vial, 0.040 g of saflufenacil was added to 0.160 ml of solvent. To prepare the 30 wt. % vial, 0.060 g of saflufenacil was added to 0.140 ml of solvent. To prepare the 40 wt. % vial, 0.80 g of saflufenacil was added to 0.120 ml of solvent. To prepare the 50 wt. % vial, 0.100 g of saflufenacil was added to 0.100 ml of solvent. The vials were capped and swirled at room temperature until no change in solubility was observed.

The results are shown in Table 2 below. Table 2 shows the maximum weight percentage of saflufenacil dissolved in each solvent, as described above. Solvents 1-3 are in accordance with the present disclosure. Solvents 4-13 are comparative solvents. As shown in Table 2, the N-methylcaprolactam performed nearly as well as NMP, and better than any other comparative solvent.

TABLE 2
Saflufenacil

| | | |
|---|---|---|
| 1 | N-methylcaprolactam | 40% |
| 2 | N-ethylcaprolactam | 30% |
| 3 | N-butylcaprolactam | 20% |
| 4 | N-methyl-2-pyrrolidone | 50% |
| 5 | N-butyl-2-pyrrolidone | 30% |
| 6 | N,N-dimethyldecanamide | 30% |
| 7 | N,N-dimethyladipamide methyl ester | <20% |
| 8 | methyl-5-(dimethylamino)-2-methyl-5- | 20% |
| | oxopentanoate | |
| 9 | cyclohexanone | <20% |
| 10 | cyclohexyl methyl ether | <20% |
| 11 | cyclohexyl acetate | <20% |
| 12 | cyclohexyl butyrate | <20% |
| 13 | N-(2-cyanoethyl)caprolactam | <20% |

### Example 2—Insecticide Comparative Solubility

Test samples including the insecticide bifenthrin were prepared as described above for Example 1 for saflufenacil. The results are shown in Table 3 below. Table 3 shows the maximum weight percentage of bifenthrin dissolved in each solvent, as described above. As in Table 1 above, solvents 1-3 are in accordance with the present disclosure and solvents 4-13 are comparative solvents. As shown in Table 3, the N-ethylcaprolactam performed as well as NMP.

TABLE 3
Bifenthrin

| | | |
|---|---|---|
| 1 | N-methylcaprolactam | 40% |
| 2 | N-ethylcaprolactam | 50% |
| 3 | N-butylcaprolactam | 40% |
| 4 | N-methyl-2-pyrrolidone | 50% |
| 5 | N-butyl-2-pyrrolidone | 50% |
| 6 | N,N-dimethyldecanamide | 30% |
| 7 | N,N-dimethyladipamide methyl ester | 30% |
| 8 | methyl-5-(dimethylamino)-2-methyl-5- | 30% |
| | oxopentanoate | |
| 9 | cyclohexanone | 50% |
| 10 | cyclohexyl methyl ether | 50% |
| 11 | cyclohexyl acetate | 40% |
| 12 | cyclohexyl butyrate | 40% |
| 13 | N-(2-cyanoethyl)caprolactam | <20% |

### Example 3—Fungicide Comparative Solubility

Test samples including the fungicide tebuconazole were prepared as described above for Example 1 for saflufenacil. The results are shown in Table 4 below. Table 4 shows the maximum weight percentage of tebuconazole dissolved in each solvent, as described above. As in Table 1 above, solvents 1-3 are in accordance with the present disclosure and solvents 4-13 are comparative solvents. As shown in Table 4, the N-methylcaprolactam and the N-ethylcaprolactam performed as well as NMP.

TABLE 4
Tebuconazole

| | | |
|---|---|---|
| 1 | N-methylcaprolactam | 50% |
| 2 | N-ethylcaprolactam | 50% |
| 3 | N-butylcaprolactam | 40% |
| 4 | N-methyl-2-pyrrolidone | 50% |
| 5 | N-butyl-2-pyrrolidone | 40% |
| 6 | N,N-dimethyldecanamide | 30% |
| 7 | N,N-dimethyladipamide methyl ester | 30% |
| 8 | methyl-5-(dimethylamino)-2-methyl-5- | 30% |
| | oxopentanoate | |
| 9 | cyclohexanone | 40% |
| 10 | cyclohexyl methyl ether | 20% |
| 11 | cyclohexyl acetate | 20% |
| 12 | cyclohexyl butyrate | <20% |
| 13 | N-(2-cyanoethyl)caprolactam | <20% |

What is claimed is:

1. A composition comprising:
a caprolactam-derived solvent according to the general formula: 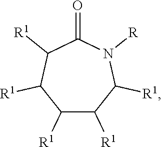
wherein R is a linear, branched, or cyclic alkyl group of 1 to 6 unsubstituted or substituted carbons and R¹ are independently selected from the group consisting of: H or an alkyl group with substituted or unsubstituted carbons; and
a crop protective active ingredient dissolved in the caprolactam-derived solvent.

2. The composition of claim 1, wherein the caprolactam-derived solvent is according to the general formula: 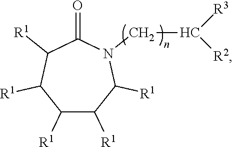
wherein n is 0 or 1; R¹ are independently selected from the group consisting of: H or an alkyl group with substituted or unsubstituted carbons; R² is independently selected from the group consisting of: H or —CH₃; and R³ is independently selected from the group consisting of: H, —CH₃, a fluoro alkyl of 1 to 3 carbons, and —C(O)NR⁴R⁴, wherein R⁴ is selected from the group consisting of: —CH₃ or —CH₂CH₃.

3. The composition of claim 1, wherein the caprolactam-derived solvent includes at least one selected from the group of N-methylcaprolactam, N-ethylcaprolactam, and N-butylcaprolactam.

4. The composition of claim 1, wherein a concentration of the caprolactam-derived solvent is from 5 weight percent to 50 weight percent of the composition.

5. The composition of claim 1, wherein the crop protective active ingredient includes at least one selected from the group of an herbicide, an insecticide, and a fungicide.

6. The composition of claim 5, wherein the crop protective active ingredient includes the herbicide, the herbicide including at least one selected from the group of ametryne, diuron, linuron, chlortoluron, isoproturon, nicosulfuron, metamitron, aclonifen, atrazine, bromoxynil, bromoxynil heptanoate, bromoxynil octanoate, phenmedipham, propanil, a heteroaryloxyphenoxy series, MCPA (2-methyl-4-chlorophenoxyacetic acid), 2,4-D (2,4-dichlorophenoxyacetic acid), simazine, an imidazolinone, alachlor, diclofop-methyl, fenoxaprop-p-ethyl, bensulfuron-methyl, chlorimuron-ethyl, chlorsulfuron, metsulfuron-methyl, nicosulfuron, sulfometuron-methyl, triasulfuron, tribenuron-methyl, phenmedipham, pendimethalin, trifluralin, oxyfluorfen, fenoxaprop-ethyl, fluazifop-p-butyl, and saflufenacil.

7. The composition of claim 5, wherein the crop protective active ingredient includes the insecticide, the insecticide including at least one selected from the group of diazinon, a phenoxyphenoxy series, azinphos-ethyl, azinphos-methyl, chlorpyrifos, methoxychlor, cypermethrin, fenoxycarb, neonicotinoid insecticides, alpha-cypermethrin, dimethoate, imidacloprid, propoxur, deltamethrine, fenvalerate, abamectin, am icarbazone, bifenthrin, carbosulfan, cyfluthrin, etofenprox, fipronil, fenvalerate, flufenoxuron, hexazinone, lambda-cyhalothrin, methomyl, and permethrin.

8. The composition of claim 5, wherein the crop protective active ingredient includes the fungicide, the fungicide including at least one selected from the group of chlorothalonil, mancozeb, maneb, zineb, cymoxanil, chlorothalonil, azaconazole, bromuconazole, cyproconazole, difenoconazole, diniconazole, epoxiconazole, fenbuconazole, flusilazole, myclobutanil, tebuconazole, triadimefon, triadimenol, pyraclostrobin, picoxystrobin, azoxystrobin, famoxadone, kresoxim-methyl, trifloxystrobin, triadimenol, benomyl, prochloraz, and propiconazole.

9. The composition of claim 1, wherein a concentration of the crop protective active ingredient is from 5 weight percent to 75 weight percent of the composition.

10. The composition of claim 1, further including an emulsifier.

11. The composition of claim 10, wherein the emulsifier includes at least one selected from the group of ethoxylated glycerin/fatty acid esters, glycerol monooleate, glycerol dioleate, PEG alkoxylated block polymers, alkoxylated alcohols, alkoxylated alkylphenols, alkoxylated amines, alkoxylated amides, alkoxylated fatty esters, alkoxylated oils, fatty esters, alkoxylated fatty acids, sorbitan derivatives, alkylaryl sulfonates, alkylaryl sulfonic acids, carboxylated alcohol ethoxylates, alkylphenol ethoxylates, carboxylic acids, diphenyl sulfonate derivatives, olefin sulfonates, phosphate esters, phosphorous organic derivatives, and quaternary surfactants.

12. The composition of claim 10, wherein a concentration of the emulsifier is from 5 weight percent to 15 weight percent of the composition.

13. The composition of claim 1, further including a co-solvent.

14. The composition of claim 13, wherein the co-solvent includes at least one selected from the group of C₉-C₁₂ hydrocarbon solvents, aliphatic paraffinic oils, aromatic solvents, C₉-C₁₂ aromatic solvents, chlorinated hydrocarbons, alcohols, ketones, ethers, vegetable oils, methylated vegetable oils, petroleum oils, and sugar esters of fatty acids.

15. The composition of claim 13, wherein a concentration of the co-solvent is from 15 weight percent to 70 weight percent of the composition.

16. An emulsifiable concentrate comprising:
a caprolactam-derived solvent according to the general formula: 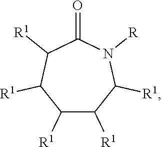
wherein R is a linear, branched, or cyclic alkyl group of 1 to 6 unsubstituted or substituted carbons and R¹ are independently selected from the group consisting of: H or an alkyl group with substituted or unsubstituted carbons;
a crop protective active ingredient dissolved in the caprolactam-derived solvent an organic co-solvent; and
an emulsifier.

17. The emulsifiable concentrate of claim 16, wherein the caprolactam-derived solvent is according to the general formula: 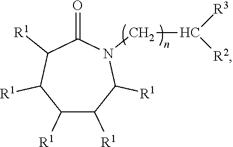
wherein n is 0 or 1; R¹ are independently selected from the group consisting of: H or an alkyl group with substituted or unsubstituted carbons; R² is independently selected from the group consisting of: H or —CH₃; and R³ is independently selected from the group consisting of: H, —CH₃, a fluoro alkyl of 1 to 3 carbons, and —C(O)NR⁴R⁴, wherein R⁴ is selected from the group consisting of: —CH₃ or —CH₂CH₃.

18. The emulsifiable concentrate of claim 16, wherein the caprolactam-derived solvent includes at least one selected from the group of N-methylcaprolactam, N-ethylcaprolactam, and N-butylcaprolactam.

19. The emulsifiable concentrate of claim 16, wherein the crop protective active ingredient includes at least one selected from the group of an herbicide, an insecticide, and a fungicide.

20. The emulsifiable concentrate of claim 16, wherein the emulsifier includes at least one selected from the group of ethoxylated glycerin/fatty acid esters, glycerol monooleate, glycerol dioleate, PEG alkoxylated block polymers, alkoxylated alcohols, alkoxylated alkylphenols, alkoxylated amines, alkoxylated amides, alkoxylated fatty esters, alkoxylated oils, fatty esters, alkoxylated fatty acids, sorbitan derivatives, alkylaryl sulfonates, alkylaryl sulfonic acids, carboxylated alcohol ethoxylates, alkylphenol ethoxylates, carboxylic acids, diphenyl sulfonate derivatives, olefin sulfonates, phosphate esters, phosphorous organic derivatives, and quaternary surfactants.
